(19) United States
(12) Patent Application Publication
(10) Pub. No.: US 2015/0300581 A1
(43) Pub. Date: Oct. 22, 2015

(54) PORTABLE BLUETOOTH CAMPING LIGHT

(71) Applicant: Chia-Ling HUANG, Taichung City (TW)

(72) Inventor: Chia-Ling HUANG, Taichung City (TW)

(21) Appl. No.: 14/256,774

(22) Filed: Apr. 18, 2014

(51) Int. Cl. F21L 4/00; F21V 23/00; H04R 1/02; H05B 37/02; H05B 33/08; F21V 33/00; F21V 7/06

(52) U.S. Cl. CPC F21L 4/00; F21V 33/0056; F21V 23/009; F21V 7/06; H05B 37/0272; H05B 33/0845; H04R 1/028; F21Y 2101/02

(57) ABSTRACT

A portable Bluetooth camping light includes a lamp body, a battery unit, a speaker, and a remote controller. The remote controller is allowed to remotely control the intensity of the light beam of the first illumination source. The lamp body is used to receive the sound information of a handheld device for broadcasting through the speaker. The battery unit is allowed to charge an external electronic device.

### BACKGROUND OF THE INVENTION

1. Field of the Invention

The present invention relates to camping lights, and more particularly, to a portable Bluetooth camping light.

2. Description of the Related Art

More and more people tend to have outdoor leisure activities, especially camping activity for wild survival experience. Camping allows people to contact the nature and have physical and mental relaxation.

Therein, camping light provides the function of illumination in a variety of activities during night time, playing an important role. However, conventional camping lights only possess the usage of illuminating without additional functions. Moreover, conventional camping lights are usually put aside in a certain distance from the campers. As a result, when the campers need to adjust the intensity of the light, the campers have to physically get close to the camping light, which is inconvenient for the campers attending activities.

### SUMMARY OF THE INVENTION

The present invention discloses a portable Bluetooth camping light, which applies the method of remote controlling for modulating the intensity of illumination, thus improving the convenience of usage.

For achieving such objectives, the present invention provides a portable Bluetooth camping light, comprising:

a lamp body, provided with a first illumination source;

a battery unit;

a speaker; and

a remote controller.

Therein, the remote controller is allowed to remotely control the intensity of the beam light of the first illumination source. The lamp body receives a wireless signal from a handheld device, and voice information is allowed to be broadcasted through the speaker. The battery unit is allowed to be charged by an external electronic device.

Further, the lamp body of the present invention is internally provided with a processor electrically connected with a first wireless module and a first switch circuit, while the first wireless module is wirelessly connected with the remote controller, whereby the camper is allowed to use the remote controller to modulate the intensity of the light projected by the first illumination source without the necessity of physically getting close to the lamp body. Therefore, the convenience of using the present invention is offered.

Further, the first illumination source of the present invention is electrically connected with the processor through the first switch circuit, wherein the first switch circuit is driven by the first rotary switch, whereby the camper is allowed to manually adjust the intensity of the light projected by the first illumination source.

Further, the lamp of the present invention comprises a Bluetooth module matched with the handheld device, while a second switch circuit and a second illumination source are electrically connected with the processor. The second switch circuit has a first ON mode, a second ON mode, and an OFF mode. When the second switch circuit is in the first ON mode, the Bluetooth module is connected with the handheld device; when the second switch circuit is in the second ON mode, both of the Bluetooth mode and the second illumination source are switched-on; when the second switch circuit is in the OFF mode, both of the Bluetooth mode and the second illumination source are switched-off.

Further, the second switch circuit is driven by a second rotary switch, whereby the second illumination source and the Bluetooth module are manually switched-on and switched-off.

### BRIEF DESCRIPTION OF THE DRAWINGS

FIG. 1 is a perspective view of the camping light in accordance with the present invention.

FIG. 2 is a sectional view of the camping light in accordance with the present invention.

FIG. 3 is a circuit block diagram of the camping light in accordance with the present invention.

FIG. 4 is a schematic block diagram illustrating the circuit connection of the second switch circuit in accordance with the present invention.

FIG. 5 is a schematic block diagram illustrating the electrical connection of the remote controller and the lamp body in accordance with the present invention.

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion.

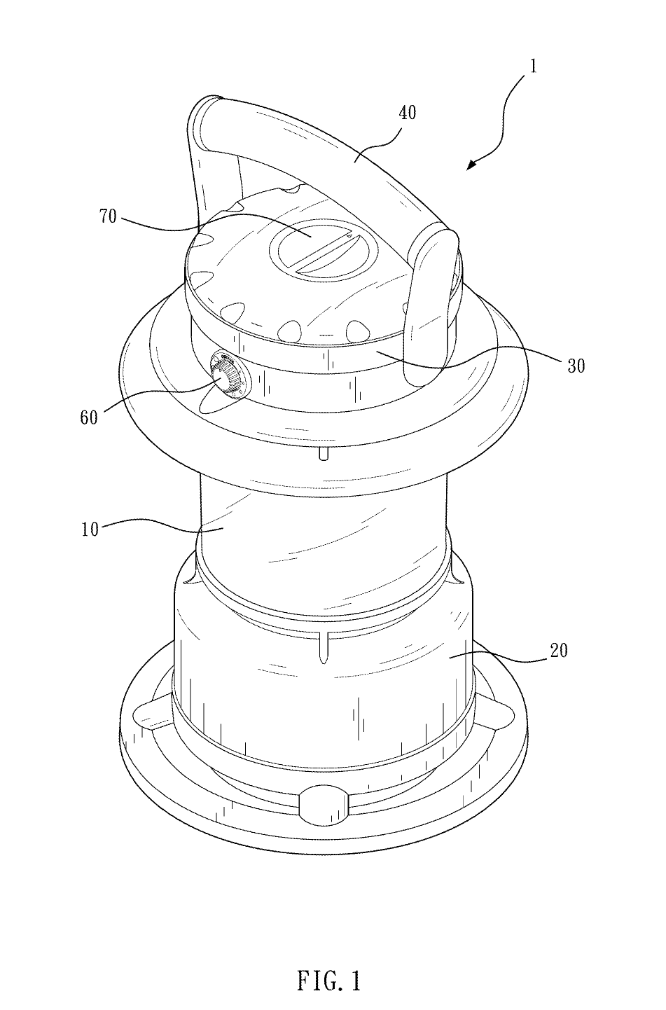

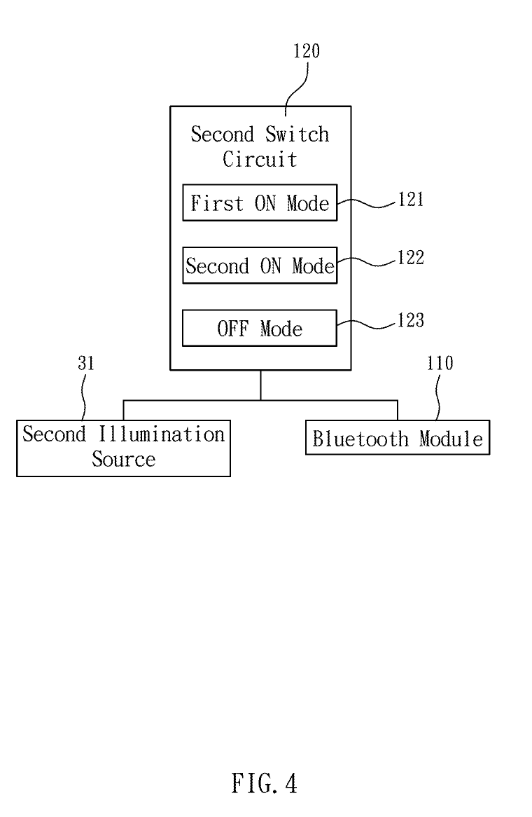

Referring to FIG. 1 to FIG. 4, the portable Bluetooth camping light comprises a lamp body 1, which is provided with a seat 20, a cap 30, and a handle 40 pivotally disposed in the cap 30.

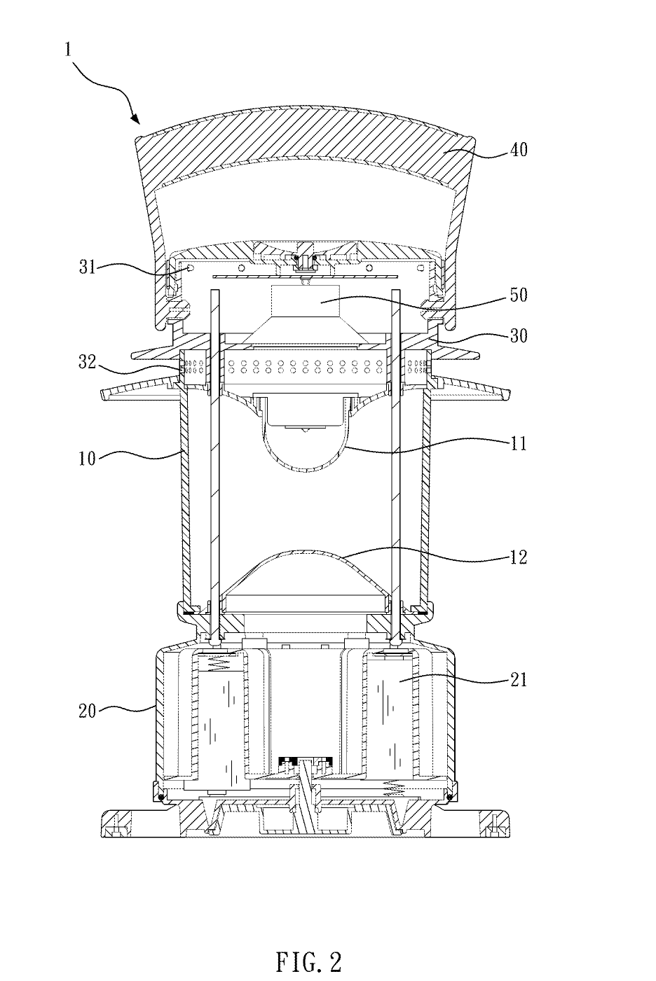

The lamp body 1 is provided with a transparent peripheral surface 10 disposed between the seat 20 and the cap 30. A first illumination source 11 and a lamp cup 12 for reflecting the light beam projected by the first illumination source 11 are oppositely disposed in the peripheral surface 10. Referring to FIG. 2, the lamp cup 12 is disposed adjacent to the seat 20 and the first illumination is disposed adjacent to the cap 30.

The seat 20 is internally provided with a battery unit 21, wherein the battery unit 21 is plural dry cells, which is a plural D size battery in the preferred embodiment.

The cap 30 is light permeable for a second illumination source 31, a plurality of LED lamps, to be disposed therein. In the embodiment of the present invention, the LED lamps are red light LED lamps, and plural sound holes 32 are disposed on the peripheral edge of the cap 30.

The lamp body 1 of the present invention further comprises a speaker 50, a first rotary switch 60, and a second rotary switch 70. The speaker 50 is disposed in the cap 30, whereby the sound produced by the speaker 50 is broadcasted through the sound holes 32. The first rotary switch 60 and the second rotary switch 70 are disposed on the periphery edge of the cap 30, respectively, wherein the first rotary switch 60 is transversely disposed on the cap 30 for controlling the ON and OFF status of the first illumination source 11 and modulating the intensity of the light beam; the second rotary switch 70 is axially disposed on the cap 30 for controlling the ON and OFF status of the second illumination source 31.

Further, the lamp body 1 is internally provided with a processor 80, a first wireless module 90, a first switch circuit 100, a Bluetooth module 110, a second switch circuit 120, and a charging module 130, and a remote controller 200 for remotely controlling the lamp body 1.

The first illumination source 11 is electrically connected with the processor 80 through the first switch circuit 100 for controlling the ON and OFF status of the first illumination source 11. Preferably, the first switch circuit 100 is driven by the first rotary switch 60 for manually controlling the ON and OFF status of the first illumination source 11 and modulating the intensity of the light beam.

The first wireless module 90 is electrically connected with the processor 80 and the first switch circuit 100, respectively, while the first wireless module 90 receives the wireless signal produced from the remote controller 200 for communicationally connecting the first wireless module 90 and the remote controller 200, whereby the remote controller 200 remotely controls the intensity of the light beam of the first illumination source 11. Therefore, the camper is allowed to remotely modulate the intensity of the light beam of the first illumination source 11 without necessity of physically getting close to the lamp body 1.

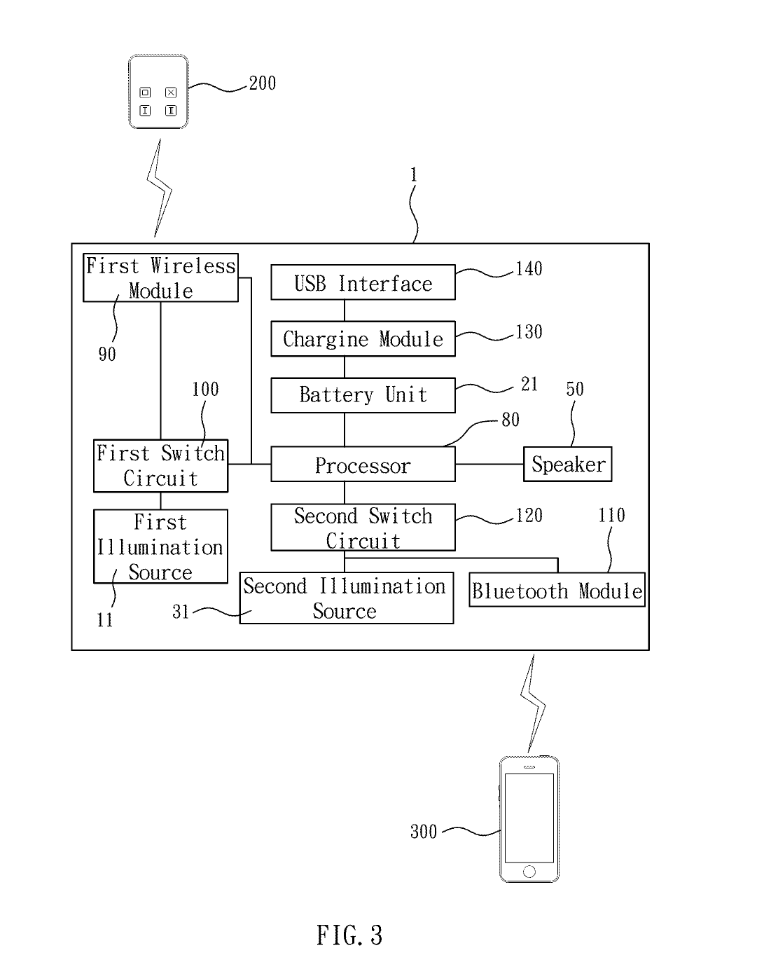

The Bluetooth module 110 is electrically connected with the processor 80 through the second switch circuit 120, while the second switch circuit 120 is also electrically connected with the second illumination source 31. Therein, as shown in FIG. 3, the second switch circuit 120 has a first ON mode 121, a second ON mode 122, and an OFF mode 123. The first ON mode 121 and the OFF mode 123 are used for controlling the connection between the Bluetooth module 110 and a handheld device 300. When the Bluetooth module 110 is matched with the handheld device 300, the sound information is output through the speaker 50, wherein the handheld device 300 of the present invention is allowed to be a mobile phone, a tablet PC, or a laptop.

Also, in the second ON mode 122, the Bluetooth module 110 and the second illumination source 31 are switched-on simultaneously, while in the OFF mode 123, the Bluetooth module 110 and the second illumination source 31 are switched-off simultaneously. Preferably, the second switch circuit 120 is driven by the second rotary switch 70 for manually controlling the second illumination source 31 and the ON and OFF status of the Bluetooth module 110.

The charging module 130 is electrically connected with the battery unit 21 for charging an external electronic device. Preferably, the charging module 130 is connected with the electronic device through an USB interface 140 and then a wire connected with the USB interface, wherein the electronic device is allowed to be a mobile phone, a tablet PC, or a laptop aforementioned. As a result, the present invention possesses the function of an emergency power supplier.

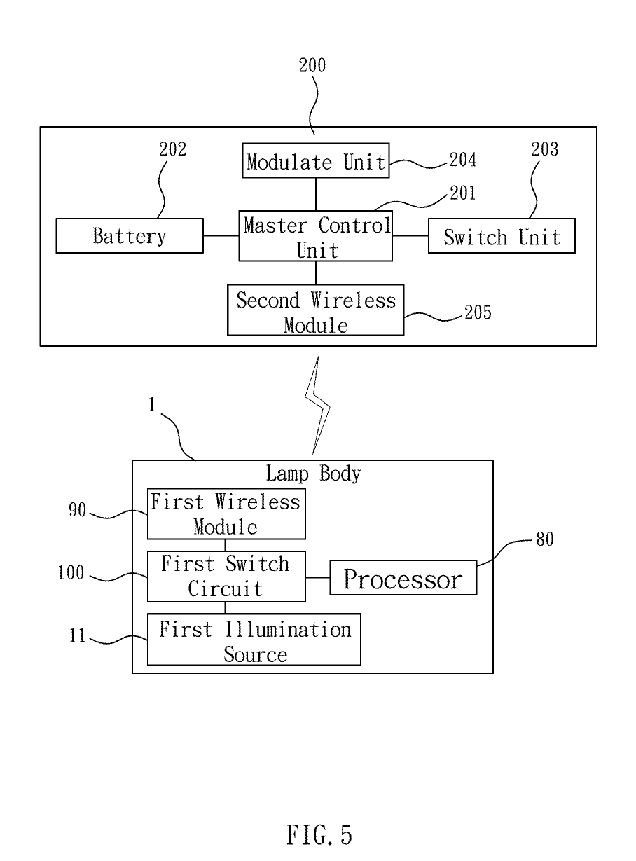

Referring to FIG. 5, which is a schematic block diagram illustrating the electrical connection of the remote controller 200 and the lamp body 1, the remote controller 200 comprises a master control unit 201, a battery 202, a switch unit 203, a modulate unit 204, and a second wireless module 205. The battery 202, the switch unit 203, the modulate unit 204, and the second wireless module 205 are connected with the master control unit 201, while the second wireless module 205 is communicationally connected with the first wireless module 90, whereby the remote controller 200 remotely modulates the intensity of the light beam from the first illumination source 11 through the modulate unit 204. In the present invention, the second wireless module 205 is allowed to be connected with the first wireless module 90 through infrared ray, Bluetooth, or other equivalent wireless connection.

Therefore, besides the basic illuminating function, the lamp body 1 of the present invention is allowed to be placed in a camping area. When the intensity of the light beam of the lamp body 1 needs to be modulated, the camper is able to modulate the intensity of the light beam from the first illumination source 11 of the lamp body 1, whereby the camper does not need to physically get close to the lamp body 1, offering convenience for operation. Furthermore, the lamp body 1 of the present invention possesses the function of being connected with the handheld device 300 through the Bluetooth protocol, whereby the sound or music of the handheld device 300 is broadcasted by the speaker 50 of the lamp body 1, increasing the functions of the lamp body 1 and bringing different recreational effects during the camping activity.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A portable Bluetooth camping light, comprising:
a lamp body possessing a transparent peripheral surface with a first illumination source disposed therein;
a processor, disposed in the lamp body and electrically connected with the first illumination source for modulating the ON and OFF status of the first illumination source;
a battery unit, disposed in the lamp body and electrically connected with the processor;
a speaker, disposed in the lamp body and electrically connected with the processor;
a Bluetooth module, disposed in the lamp body and electrically connected with the processor, while the Bluetooth is matched with a handheld device, whereby the sound information is broadcasted through the speaker;
a first wireless module, disposed in the lamp body and electrically connected with the processor; and
a remote controller, remotely connected with the first wireless module for controlling the intensity of the light beam of the first illumination source.

2. The camping light of claim 1, wherein the first illumination source is electrically connected with the processor and the first wireless module through a first switch circuit.

3. The camping light of claim 2, wherein the first switch circuit is driven by a first rotary switch for manually modulating the intensity of the light beam of the first illumination source.

4. The camping light of claim 1, wherein the remote controller comprises a master control unit, a battery unit connected with the master control unit, a switch unit, a modulate unit, and a second wireless modulate, while the second wireless module is communicationally connected with the first wireless module, thereby remotely modulating the intensity of the light beam of the first illumination source through the modulate unit.

5. The camping light of claim 1, wherein the Bluetooth module is electrically connected with a second switch circuit, while the second switch circuit comprises a first ON mode and an OFF mode for controlling the connection between the Bluetooth and the handheld device.

6. The camping light of claim 5, wherein the second switch circuit is further connected with a second illumination source, and the second switch circuit further comprises a second ON mode, while the second illumination source and the Bluetooth module are switched-on simultaneously when the second switch circuit is in the second ON mode, and the second illumination source and the Bluetooth module are switched-off simultaneously when the second switch circuit is in the OFF mode.

7. The camping light of claim 6, wherein the second switch circuit is driven by a second rotary switch for manually controlling the ON and OFF status of the second illumination source and the Bluetooth module.

8. The camping light of claim 6, wherein the lamp body comprises a seat and a light permeable cap, while the transparent peripheral surface is disposed between the seat and the cap, with the second illumination source disposed in the cap.

9. The camping light of claim 8, wherein the second illumination is a plurality of LED lamps.

10. The camping light of claim 8, wherein the battery unit is disposed in the seat.

11. The camping light of claim 8, wherein the speaker is disposed in the cap, while plural sound holes are disposed on the peripheral edge of the cap.

12. The camping light of claim 1, wherein battery unit is electrically connected with a charging module for charging an external electronic device.

13. The camping light of claim 12, wherein the charging module is connected with the electronic device through an USB interface and then a wire connected with the USB interface.

14. The camping light of claim 1, wherein the battery unit is a dry cell.

15. The camping light of claim 1, wherein the transparent peripheral surface is internally provided with a lamp cup for reflecting the light beam projected by the first illumination source, while the lamp cup is disposed on the opposite side of the first illumination source.
